(19) United States
(12) Patent Application Publication
(10) Pub. No.: US 2007/0283898 A1
(43) Pub. Date: Dec. 13, 2007

(54) Vehicular animal carrier

(76) Inventor: Mark E. Madison, Phoenix, AZ (US)

Correspondence Address: LITMAN LAW OFFICES, LTD., P.O. BOX 15035, CRYSTAL CITY STATION, ARLINGTON, VA, 22215, US

(21) Appl. No.: 11/785,593

(22) Filed: Apr. 18, 2007

Related U.S. Application Data
(60) Provisional application No. 60/793,323, filed on Apr. 20, 2006.

(51) Int. Cl. A01K 1/00

(52) U.S. Cl. 119/496

(57) ABSTRACT

The vehicular animal carrier is a vehicle door-mounted support for an animal, such as a small dog. The vehicular animal carrier includes a platform having a peripheral wall defining a recess adapted for receiving the animal. A rear wall is mounted to a rear end of the platform and projects upwardly therefrom. An upper portion of the rear wall arcuately projects rearwardly therefrom. A planar member projects downwardly from the top edge of the rear wall, forming a hook. The planar member is inserted between the vehicle window and an inner portion of the vehicle door to support the platform above the vehicle seat. A pair of side plates may be releasably mounted to side edges of the platform in order to provide shade for the animal. A pad layer may be placed within the recess for the animal's comfort.

### CROSS-REFERENCE TO RELATED APPLICATION

This application claims the benefit of U.S. Provisional Patent Application Ser. No. 60/793,323, filed Apr. 20, 2006.

### BACKGROUND OF THE INVENTION

1. Field of the Invention

The present invention relates to pet carriers and animal transport devices, and particularly to a vehicular animal carrier that hooks onto a vehicle door for transporting small pets, such as a small dog.

2. Description of the Related Art

Pet owners, particularly the owners of small dogs, frequently have occasion to transport their pet by automobile. Sometimes the automobile trip may be required, e.g., a trip to the veterinarian, while on other occasions the pet owner merely desires the companionship of the pet, or to take the pet to a park or other outdoor facility for exercise.

Automobile seats, however, were made for human passengers, and automobile manufacturers usually make no provision for transporting small animals. Automobile upholstery is made from a variety of materials, including plastic, cloth, genuine or imitation leather, etc. Without a carrier, the animal is often placed on the seat. The pet may become excited during the ride, and attempt to sit up and rest the paws on the windowsill. Even when the pet has been well manicured, the pet's nails can scuff, scratch, or tear the upholstery.

While various pet carriers have been developed for transporting animals in a variety of circumstances, most such carriers are designed to rest on the floor of the vehicle, or on the seat, where movement or shifting of the carrier can gouge or scratch the upholstery. The variety of pet carriers available attests that none have been entirely satisfactory for transporting a small animal in a vehicle. Thus, a vehicular animal carrier solving the aforementioned problems is desired.

### SUMMARY OF THE INVENTION

The vehicular animal carrier is a vehicle door-mounted support for an animal, such as a small dog, for example. The vehicular animal carrier includes a platform having a recess formed therein, with the recess being adapted for receiving the animal. A rear wall is mounted to a rear end of the base and projects upwardly therefrom. The upper portion of the rear wall curves rearward, and a planar member extends downward from the top edge of the rear wall to form a hook that can be inserted in the slot between a vehicle window and an inner portion of the vehicle door in order to support the platform above the vehicle seat.

A pair of side plates may be releasably mounted to side edges of the platform in order to provide shade for the animal. Preferably, each of the plates is formed from an at least partially opaque material. Each of the side plates includes a lower edge having at least one tab projecting downwardly therefrom. Slots are formed in the side edges of the platform for releasably receiving the tabs of the pair of releasable plates.

A pad or cushion may be placed within the platform recess for the animal's comfort. Also, a cage may be received within the recess for holding the animal therein in a secure manner.

These and other features of the present invention will become readily apparent upon further review of the following specification and drawings.

### BRIEF DESCRIPTION OF THE DRAWINGS

FIG. 1 is an environmental, perspective view of a vehicular animal carrier according to the present invention.

FIG. 2 is an exploded perspective view of the vehicular animal carrier according to the present invention.

FIG. 3 is a perspective view of an alternative embodiment of the vehicular animal carrier according to the present invention.

FIG. 4 is a perspective view of another alternative embodiment of the vehicular animal carrier according to the present invention.

Similar reference characters denote corresponding features consistently throughout the attached drawings.

### DETAILED DESCRIPTION OF THE PREFERRED EMBODIMENTS

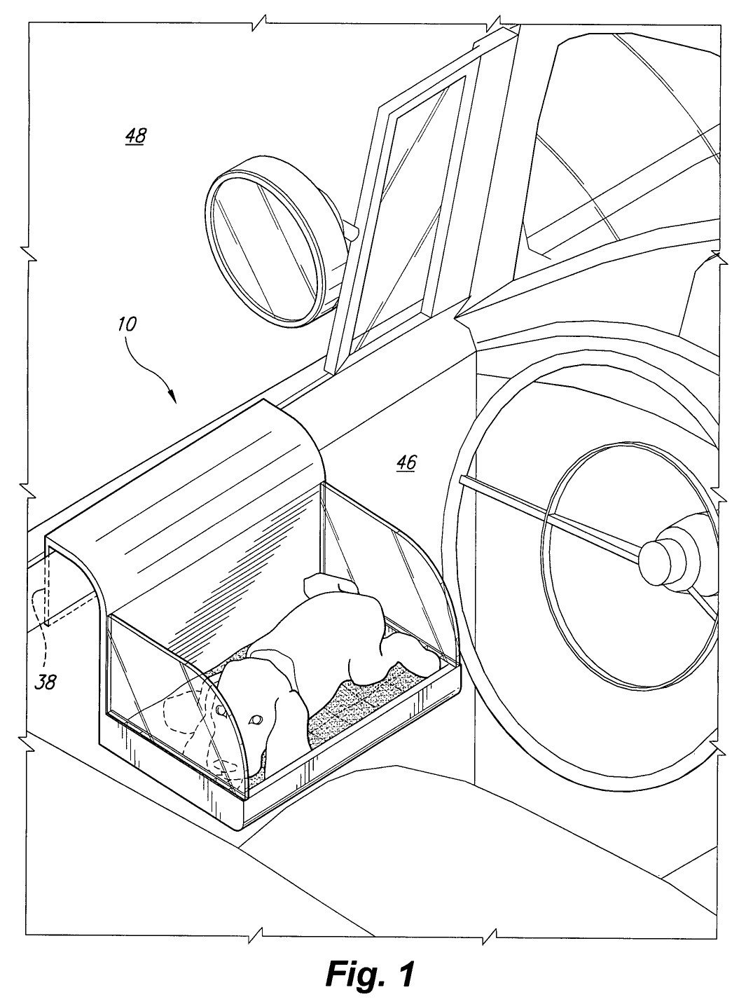

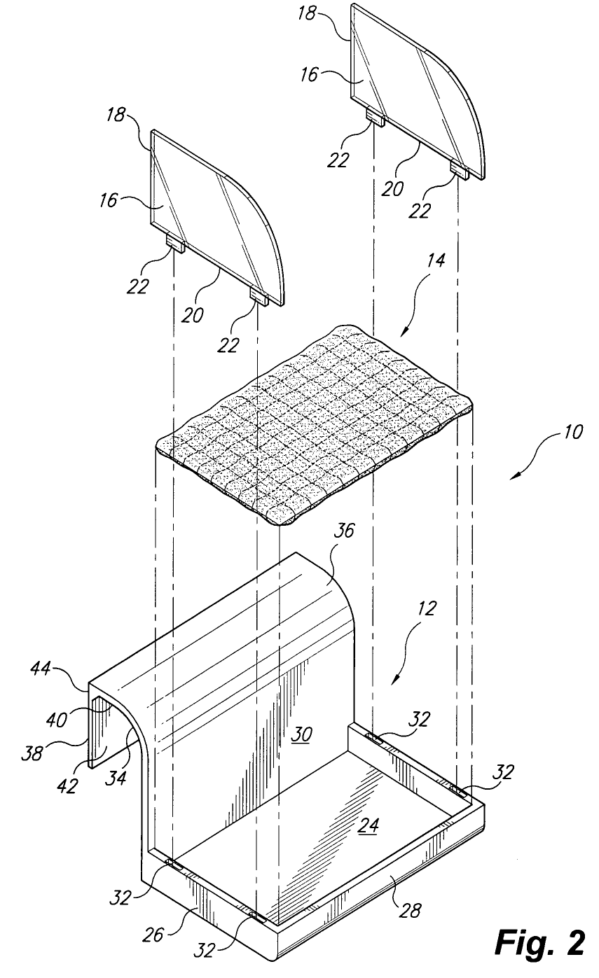

Referring to FIGS. 1 and 2, there is shown a vehicular animal carrier 10, which is a releasable vehicle door-mounted support for an animal, such as a small dog. The vehicular animal carrier 10 includes a planar member 38 (described in greater detail below), which is inserted in the slot between a vehicle window 48 and an inner panel of the vehicle door 46, as best shown in FIG. 1. The releasable mounting of the carrier 10 to the vehicle door 46 allows for comfortable, adjustable and removable support for the animal. Although shown as being mounted to a front driver's side door of an automobile, it should be understood that carrier 10 may be releasably mounted to any suitable vehicle door, or to any other suitable support surface that can receive a hook with a broad planar member 38. Further, although shown as supporting a small dog, it should be understood that carrier 10 may be used to support and transport any suitable animal, e.g., a cat, or suitable cargo.

As best shown in FIG. 2, the vehicular animal carrier 10 includes a platform 12 having a peripheral wall forming a recess therein, with the recess being adapted for receiving the animal. Preferably, the platform 12 includes a base plate 24 having an upper and a lower surface. A front wall 28 is preferably mounted to a front edge of base plate 24 and projects upwardly therefrom. A pair of opposed sidewalls 26 are each preferably mounted to a respective side edge of the base plate 24, and project upwardly therefrom, the front wall 28 and sidewalls 26 forming the peripheral wall. A rear wall 30 is mounted to a rear edge of the base plate 24 and projects upwardly therefrom. The recess for receiving the animal is preferably defined by the base plate 24, sidewalls 26, front wall 28 and rear wall 30.

It should be understood that the vehicular pet carrier 10 may have any suitable shape and size. However, in the preferred embodiment, base plate 24 preferably has a substantially rectangular contour, and is preferably approximately fourteen inches long and approximately 8.625″ wide. Further, each of the side walls 26 and the front wall 28 are preferably approximately two inches in height and ½″ in thickness. In the preferred embodiment, the rear wall 30 is preferably approximately 9½″ in height. Also, carrier 10 may be formed from any suitable material. In the preferred embodiment, carrier 10 is formed from a plastic material.

The upper portion 40 of rear wall 30 is curved and projects rearwardly therefrom. Upper portion 40 defines an upper surface 36 and a lower surface 34. Upper surface 36 may have a pattern or design formed thereon (illustrated here by exemplary horizontal line segments) for ornamentation, or may have transverse ribs formed thereon for increased strength. In use (as shown in FIG. 1), the lower surface 34 of upper portion 40 and a rear surface of rear wall 30 make contact with the inner portion of door 46. Lower surface 34 is preferably contoured to provide flush and secure contact with the door 46. In the preferred embodiment, upper portion 40 preferably extends rearwardly from rear wall 30 approximately 3 ½″.

Planar member 38 is mounted to the top edge of rear wall 30 and projects downwardly therefrom so that rear wall 30, including arcuate upper portion 40, and planar member 38 form a hook, planar member 38 being received in the slot formed in vehicle door 46 provided for vehicle window 48 and arcuate upper portion 40 bearing against the window sill. The front surface 42 planar member 38 faces the interior of door 46 and the rear face 44 of planar member 38 abuts the window 48. In use, planar member 38 is releasably sandwiched between window 48 and door 46. In the preferred embodiment, planar member 38 preferably has a substantially rectangular contour and is preferably approximately 4½″ in height and approximately ¼″ in thickness.

A pair of side plates 16 may be releasably mounted to sidewalls 26 in order to provide shade for the animal. Preferably, each of the side plates 16 is formed from an at least partially opaque material. Side plates 16 may be formed from tinted plastic, tinted glass, smoked glass or the like. Each of the side plates 16 includes a lower edge 20 having at least one tab 22 projecting downwardly therefrom. Slots 32 are formed in upper edges of the sidewalls 26 for releasably receiving the tabs 22 of the pair of side plates 16. As shown, rear edge 18 of each plate 16 contacts the front surface of rear wall 30 for securing mounting of the plates 16 to the carrier 10. The upper edge of each plate 16 is shown having an arcuate contour. However it should be understood that each plate 16 may have any suitable contour.

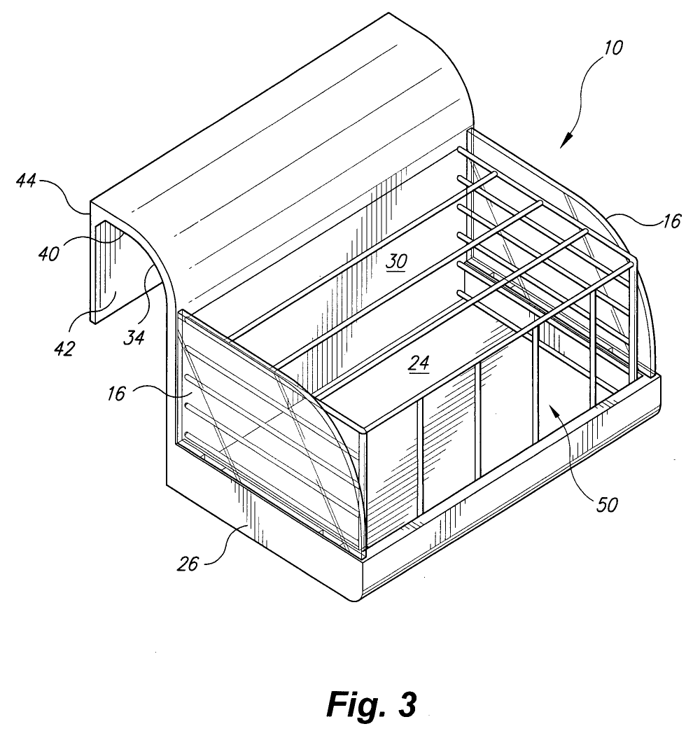

The animal may rest directly on the base plate 24, or on a cushion or pad 14 that may be received within the recess for the animal's comfort. Pad 14 may be a mattress or the like. Further, in the alternative embodiment illustrated in FIG. 3, a cage 50 may be provided within the recess for holding the animal therein in a secure manner. Cage 50 is releasably mounted on base plate 24, allowing the animal to be either freely supported on platform 12, or supported within cage 50.

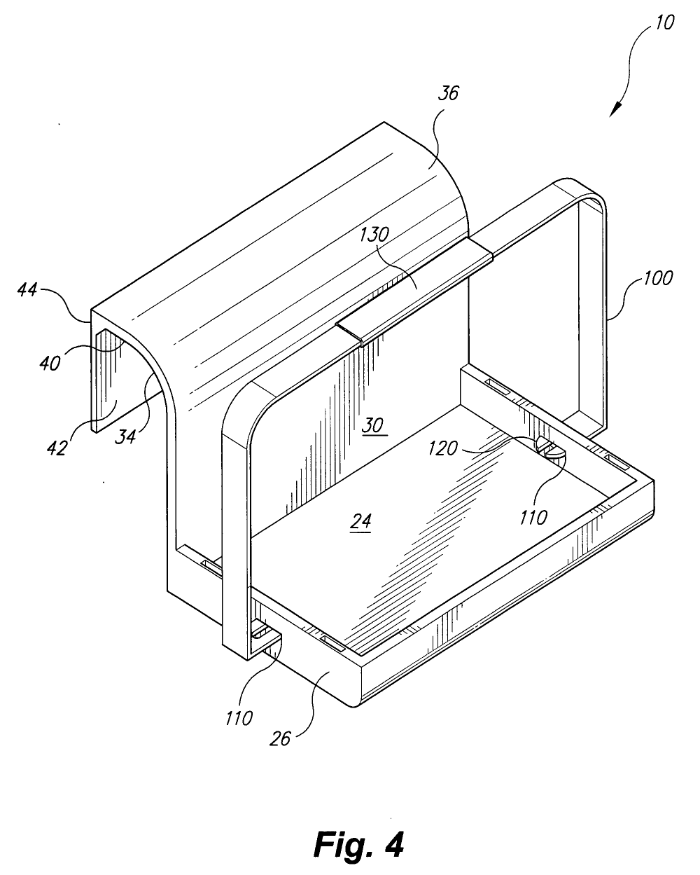

In the embodiment of FIG. 4, the vehicular animal carrier 10 includes a handle 100, allowing the user to easily carry and transport the vehicular animal carrier 10 when not in use. Sidewalls 26 each have a slot 110 formed therethrough for releasably receiving a respective locking end 120 of handle 100. In the embodiment illustrated in FIG. 4, each locking end 120 is shown as being a pronged end with a pair of resilient engaging members formed thereon, which snap into the slots 110 and have flanges that hook against the sidewalls 26 to retain the handle.

Handle 100 may have a gripping member 130 mounted thereto, as shown, for enhancing friction and/or comfort for the user's hand. Pad 14 and plates 16 are not shown in FIG. 4 for the sake of clarity, although it should be understood that both pad 14 and plates 16 may be used in combination with the carrier 10 shown in FIG. 4.

It is to be understood that the present invention is not limited to the embodiments described above, but encompasses any and all embodiments within the scope of the following claims.

I claim:

1. A vehicular animal carrier, comprising:
a platform having a peripheral wall defining a recess, the platform being adapted for supporting an animal within the recess;
a rear wall extending upward from the platform, the rear wall having an upper portion arcuately extending rearward and defining a top edge of the rear wall; and,
a planar member extending downward from the top edge of the rear wall, the upper portion of the rear wall and the planar member forming a hook adapted for mounting to a vehicle window with the planar member being inserted into a slot between the vehicle window and an inner portion of a vehicle door.

2. The vehicular animal carrier as recited in claim 1, further comprising a pair of side plates releasably attached to the peripheral wall of said platform and extending upwardly therefrom in order to provide a sunshade.

3. The vehicular animal carrier as recited in claim 2, wherein each of said side plates is formed from an at least partially optically opaque material.
